(19) United States
(12) Patent Application Publication
(10) Pub. No.: US 2011/0181793 A1
(43) Pub. Date: Jul. 28, 2011

(54) LIGHT EMITTING DEVICE FOR IMAGE DISPLAY, DISPLAY DEVICE AND TELEVISION RECEIVER

(75) Inventors: Tomohiko Yamamoto, Osaka (JP); Kohji Fujiwara, Osaka (JP); Takeshi Masuda, Osaka (JP); Kohji Iwasaki, Osaka (JP)

(73) Assignee: Sharp Kabushiki Kaisha

(21) Appl. No.: 12/737,949

(22) PCT Filed: Aug. 11, 2009
(86) PCT No.: PCT/JP2009/064152

§ 371 Date: Mar. 3, 2011

(30) Foreign Application Priority Data
Oct. 14, 2008 (JP) 2008-265614

(51) Int. Cl. H04N 3/14; G06F 3/038; H05B 37/02

(52) U.S. Cl. 348/790; 345/211; 315/307; 315/297; 345/87; 348/E03.016

(57) ABSTRACT

A light emitting device for image display includes an LED current setting circuit and an LED voltage setting circuit. In at least one embodiment, the LED current setting circuit generates a current control signal to vary an element current flowing in the LED element depending on an image display mode. The LED voltage setting circuit generates a voltage control signal to vary driving voltage driving the LED element depending on the image display mode. The light emitting device further includes a voltage generation circuit that generates the driving voltage according to the voltage control signal and the driving voltage to the LED element.

### TECHNICAL FIELD

The present invention relates to a light emitting device for image display, a display device provided with the light emitting device for image display and a television receiver including the display device, and more particularly relates to current and voltage control of the light emitting device for image display.

### BACKGROUND ART

Backlight devices using CCF (cold cathode fluorescent tubes) have been known as a lighting device (backlight device) of an image display device such as a liquid crystal television. A backlight device using a plurality of LED (Light Emitting Diode) elements (hereinafter referred to as a LED backlight device) has been recently used. Generally, following properties are known as an element property of the LED element.

Property 1: brightness (nt) is improved as LED current If increases

Property 2: voltage Vf required for driving the LED element increases as the LED current If increases

Property 3: light emission efficiency (Lm/W) is lowered as the LED current If increases

Patent Document 1 discloses a constant current driving method of the LED element to maintain constant brightness of the LED backlight device without being influenced by product variations of the LED elements having such element properties. Power saving is desired for the LED backlight device to achieve high brightness and reduce power consumption of the image display device.
[Patent Document 1] Japanese Unexamined Patent Publication No. 11-305198

### PROBLEM TO BE SOLVED BY THE INVENTION

However, to improve the brightness, the LED current If and the driving voltage Vf of the LED element are required to increase due to the properties of the LED element. This increases power consumption of the LED backlight device. High brightness and power saving of the LED backlight device cannot be achieved simultaneously due to the element properties of the LED element. Therefore, the LED backlight device (light emitting device for image display) is desired to appropriately achieve high brightness and power saving depending on an image display mode.

### DISCLOSURE OF THE PRESENT INVENTION

The present invention was made in view of the foregoing circumstances. An object of the present invention is to provide a light emitting device for image display that appropriately achieves high brightness and power saving depending on an image display mode. Another object of the present invention is to provide a display device including such a light emitting device and a television receiver including such a display device.

### MEANS FOR SOLVING THE PROBLEM

To solve the above problem, a light emitting device for image display includes an LED element and controls light emission of the LED element depending on an image display mode. The light emitting device includes an LED current setting circuit configured to generate a current control signal to vary an element current flowing in the LED element depending on the image display mode, a current control circuit configured to control the element current of the LED element according to the current control signal, an LED voltage setting circuit configured to generate a voltage control signal to vary driving voltage driving the LED element depending on the image display mode, and a voltage generation circuit configured to generate driving voltage according to the voltage control signal depending on the image display mode and apply the driving voltage to the LED element.

According to such a configuration, the element current and the driving voltage of the LED element are varied depending on the image display mode. Therefore, for example, the element current and the driving voltage increase from the normal values in the image display mode that requires high brightness rather than power saving, and the element current and the driving voltage reduce from the normal values in the image display mode that requires power saving rather than high brightness. According to the present configuration, both of the element current and the driving voltage are controlled appropriately in control of the light emission brightness and the power consumption of the LED element. Accordingly, in the light emitting device, the high brightness and power saving are appropriately achieved depending on the image display mode.

It is noted that “for image display” is used to include that the light emitting device displays an image and that the light emitting device makes other device to display an image. “Image display mode” includes any modes relating to displayed images. Especially, “image display mode” includes display modes of displayed images relating to light emission brightness and power saving of the light emitting device.

### BRIEF DESCRIPTION OF THE DRAWINGS

FIG. 1 is an exploded perspective view illustrating a general construction of a television receiver according to an embodiment of the present invention;

FIG. 2 is an exploded perspective view illustrating a general construction of a liquid crystal panel and a backlight device;

FIG. 3 is a block diagram illustrating a general electrical configuration of a liquid crystal display device;

FIG. 4 is a circuit diagram explaining an electrical configuration of an LED panel; and

FIG. 5 is a table illustrating setting examples of LED currents and LED voltages in each image display mode.

### BEST MODE FOR CARRYING OUT THE INVENTION

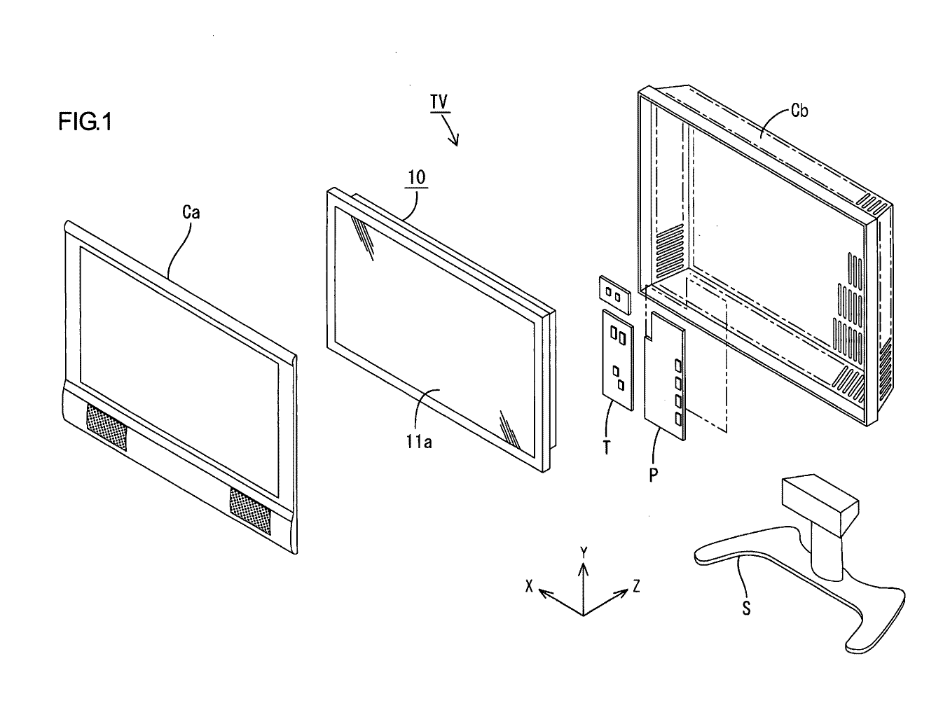

One embodiment of the present invention will be explained with reference to FIGS. 1 to 5. In the present embodiment, a television receiver TV including a liquid crystal display device 10 will be explained. Each of an X-axis, a Y-axis and a Z-axis is illustrated to have a common direction in each drawing.

1. Structure of Television Receiver

As illustrated in FIG. 1, the television receiver TV of the present embodiment includes the liquid crystal display device 10 (an example of a display device), front and rear cabinets Ca, Cb that house the liquid crystal display device 10 therebetween, a power source P and a tuner T. The liquid crystal display device 10 is supported by a stand S such that a display surface 11a is parallel to a vertical direction (Y-axis direction). The display device of the present invention may be applied to the liquid crystal display device for color display and also to the liquid crystal display device for black and white display. The display device is not limited to a liquid crystal display device but may be any devices that have a backlight device and a display panel that displays using light from the backlight device.

2. Construction of Liquid Crystal Display Device

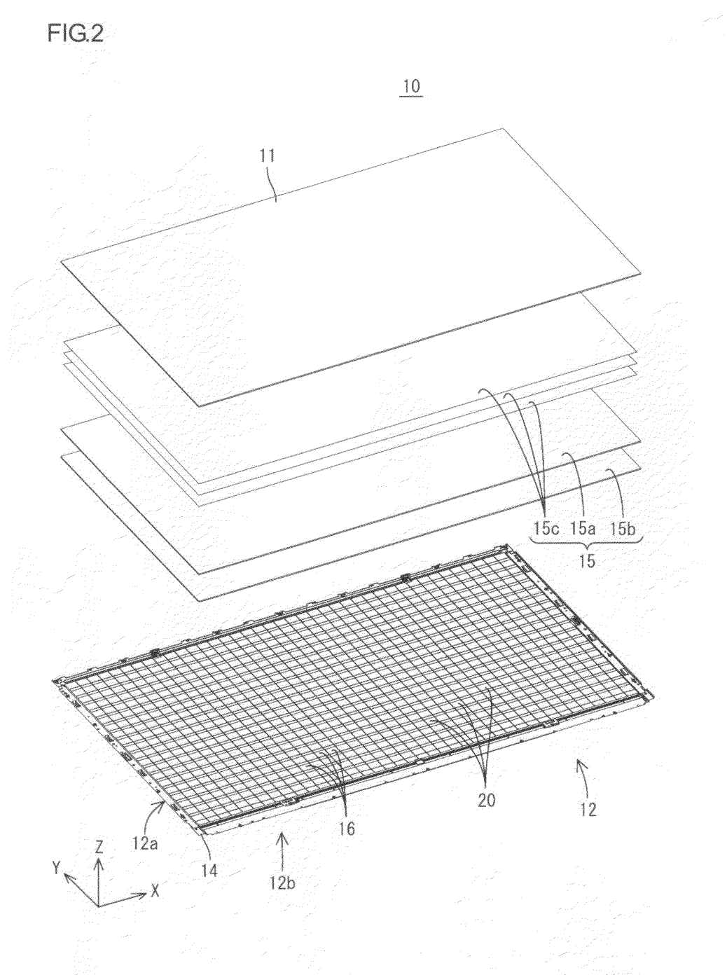

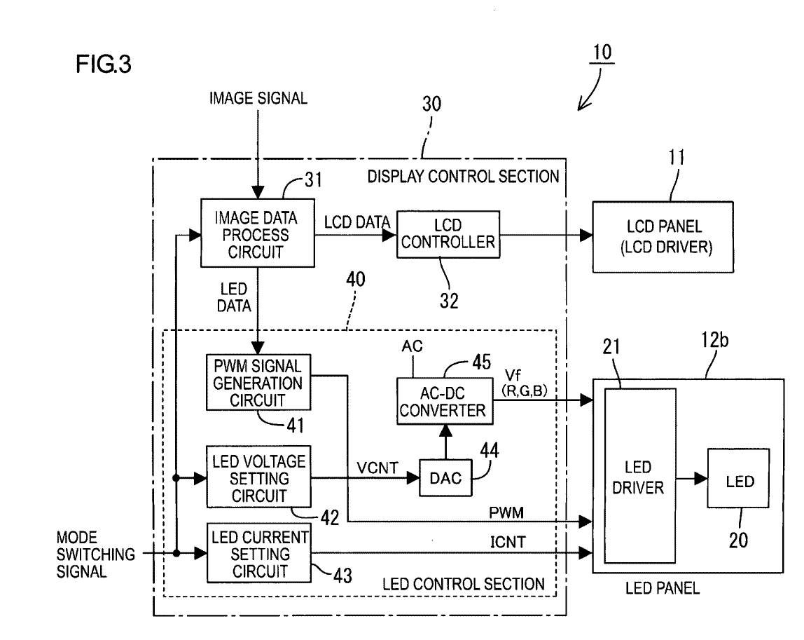

An overall shape of the liquid crystal display device 10 is a landscape rectangular. As illustrated in FIG. 2, it includes a liquid crystal panel 11 as a display panel, and an LED backlight device 12 as a light emitting device for image display. They are integrally held by a frame-shaped bezel and the like. The liquid crystal display device 10 further includes a display control section 30 (refer to FIG. 3).

Next, the liquid crystal panel (LDC panel) 11 and the backlight device 12 will be explained. The liquid crystal panel 11 is formed in a rectangular shape with a plan view and constructed such that a pair of glass substrates is bonded together with a predetermined gap therebetween and liquid crystal is sealed between the glass substrates.

On one of the glass substrates, switching components (e.g., TFTs (thin film transistors)) connected to source lines and gate lines that are perpendicular to each other, pixel electrodes connected to the switching components, and an alignment film are provided. On the other substrate, a color filter having color sections such as R (red), G (green) and B (blue) color sections arranged in a predetermined pattern, common electrodes, and an alignment film are provided.

With such a construction, for example, color pixels of 192*1080 dots for high vision are formed in the liquid crystal panel 11. Further, an LCD driver is provided in the liquid crystal panel 11 to control the switching element of each pixel.

As illustrated in FIG. 2, the LED backlight device 12 irradiates and illuminates a rear side of the liquid crystal panel 11 with light from divided regions. The LED backlight device 12 includes a LED panel 12b and an optical member 15. The optical member 15 is configured by a diffuser plates 15a, 15b and optical sheets 15c.

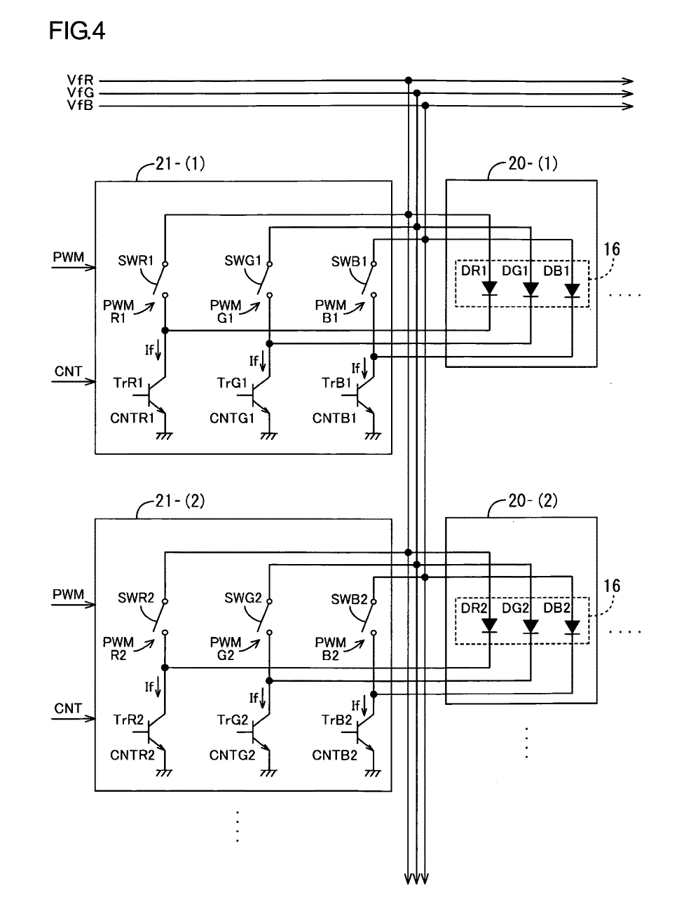

The LED panel 12b includes a plurality of LED units 20 each of which corresponds to each region, and each LED unit 20 includes an LED section 16. Each LED section 16 includes an R (red) light emitting diode DR, a G (green) light emitting diode DG and a B (blue) light emitting diode DB (refer to FIG. 4). An irradiating surface 12a of the LED backlight device 12 is divided into a plurality of regions by the LED units 20. According to the present embodiment, the LED units 20 configure the divided regions. As illustrated in FIG. 2, for example, the irradiating surface 12a is divided into 20*40 (800) regions. According to such a structure, the LED backlight device 12 including a large light emission area is preferably configured. The LED backlight device 12 corresponding to the liquid crystal panel 11 having a large screen is preferably configured. The number of LED units 20 and the number of divided regions of the irradiating surface 12a are arbitrarily set.

The liquid crystal display device 10 further includes a display control section 30 as illustrated in FIG. 3. The display control section 30 includes an image data process circuit 31, an LCD controller 32 and an LED control section 40.

The image data process circuit 31 receives an image signal (image data) from the tuner T, for example, and determines light emission brightness data (hereinafter referred to as LED data) of each light emitting diode based on the image signal. The image data process circuit 31 supplies the LED data to the LED control section 40 as a 12-bit digital signal. In the present embodiment, each light emitting diode is controlled by a PWM (pulse-width modulation) signal. Therefore, the LED data includes data relating to a PWM value (duty ratio) of the PWM signal. That is, the LED data includes PWM generation data (for example, 12-bit data) for generating the PWM signal.

The image data process circuit 31 receives a mode switching signal and varies the LED data (PWM value) depending on an image display mode. Therefore, in an image display mode that requires high brightness, the PWM value (duty ratio) increases from a normal value to obtain high brightness surely. An image display mode changing switch (not shown) is provided on an operation panel of a television receiver TV and the mode switching signal is generated in response to user's operation of the image display mode changing switch. The configuration in which the image data process circuit 31 varies the LED data (PWM value) according to the mode switching signal depending on the image display mode may be omitted.

Further, the image data process circuit 31 generates LCD data that represents light transmittance data of each pixel in the LCD panel 11 based on the image signal and supplies the LCD data to the LCD controller 32.

The LED control section 40 includes a PWM signal generation circuit 41, an LED voltage setting circuit 42, an LED current setting circuit 43, a DAC (digital-analog converter) 44 and an AC-DC (alternating current-direct current) converter 45 as a voltage generation circuit.

The PWM signal generation circuit 41 generates a PWM signal having a predetermined PWM value (duty ratio) based on the LED data from the image data process circuit 31 and supplies the PWM signal to the LED driver 21 of the LED panel 12b.

The LED voltage setting circuit 42 generates a voltage control signal VCNT according to the mode switching signal to vary the LED voltage Vf that is to be applied to the LED element depending on the image display mode. The voltage control signal VCNT is supplied to the DAC 44 and the DAC 44 converts the voltage control signal VCNT that is a digital signal to a voltage control signal VCNT that is an analog signal and supplies the analog voltage control signal VCNT to the AC-DC converter 45.

In response to the analog voltage control signal VCNT, the AC-DC converter 45 converts alternating voltage of AC100V (in Japan), for example, to predetermined LED voltage Vf that is direct current and supplies the LED voltage Vf to the LED panel 12b. The voltage generation circuit is not limited to the AC-DC converter but may be a DC-DC converter. The voltage generation circuit may be any one as long as it generates LED voltage Vf (driving voltage) according to the voltage control signal VCNT depending on the image display mode and applies the driving voltage to the LED element.

The LED current setting circuit 43 generates a current control signal ICNT according to the mode switching signal depending on the image display mode to vary the driving current If that drives the LED element. The current control signal ICNT is supplied to the LED driver 21 of the LED panel 12b.

In the present embodiment, for example, the LED driver 21 is provided for each LED unit 20 as illustrated in FIG. 4. As illustrated in FIG. 4, each LED driver 21 includes switching elements SW and current control transistors Tr (as a current control circuit) each corresponding to each light emitting diode of the LED unit 20. Each switching element SW is controlled by a PWM signal supplied from the LED control section 40. Each current control transistor Tr is controlled by a current control signal ICNT supplied from the LED control section 40. In FIG. 4, a bipolar transistor is illustrated as the current control circuit. However, it is not limited thereto but may be a FET (field-effect transistor) for example and also it is not limited to a transistor. The current control circuit may not be provided in the LED driver 21.

In FIG. 4, each LED unit 20 includes a red light emitting diode DR1, a green light emitting diode DG1 and a blue light emitting diode DB1 as light emitting diodes. According to such a configuration, white light is appropriately generated. In each of the R light emitting diode, the G light emitting diode and the B light emitting diode included in the LED unit 20, the connection time (light emission brightness) is independently controlled by the corresponding independent PWM signal.

Each light emitting diode of red, green and blue in the LED unit 20 is not necessarily controlled by the PWM signals. The configuration of the light emitting diode included in the LED unit (divided region) 20 is not limited to the one illustrated in FIG. 4. For example, the light emitting unit may include only white light emitting diodes, or may include six light emitting diodes including two for each of the colors R (reed), G (green) and B (blue).

3. Change Setting of LED Current and LED Voltage Depending on Image Display Mode

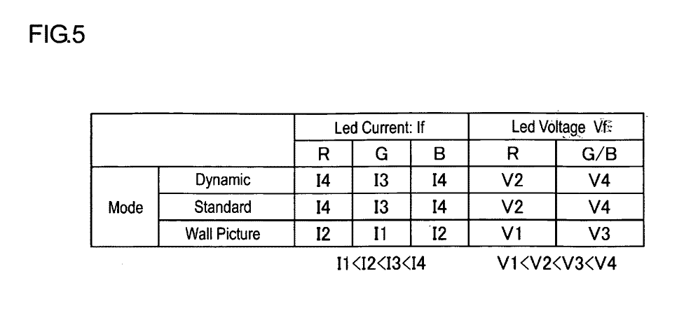

Examples of changing settings of the LED current If and the LED voltage Vf depending on the image display mode according to the present embodiment will be explained with reference to FIG. 5. For example, the image display modes of the liquid display device 10 included in the television receiver TV may include a dynamic mode, a standard mode and a Wall Picture mode in AV position function, as illustrated in FIG. 5. The image display modes are described as examples.

In the dynamic mode corresponding to a first display mode, good looking quality of images in stores is required and therefore high brightness is required rather than power saving. Therefore, if the dynamic mode is selected, the LED current If and the LED voltage Vf increase compared to the normal standard mode. Specifically, the LED voltage setting circuit 42 generates a voltage control signal VCNT according to the mode switching signal including selection information of the dynamic mode to increase the LED voltage Vf compared to the case of the standard mode and supplies the voltage control signal VCNT to the AC-DC converter 45. The AC-DC converter 45 increases the LED voltage Vf according to the voltage control signal VCNT. The LED current setting circuit 43 generates a current control signal ICNT according to the mode switching signal to increase the LED current If compared to the case of the standard mode and supplies the current control signal ICNT to each transistor Tr of the LED driver 21. Each transistor Tr increases the LED current Vf according to the current control signal ICNT.

In the present embodiment, as illustrated in FIG. 5, each of the LED voltage Vf and the LED current If can be set for each LED element (DR, DG, DB) of each color R, G and B. Therefore, in the present embodiment, each of the LED current If and the LED voltage Vf is changed depending on the image display mode. In such a case, each of the LED current If and the LED voltage Vf can be changed independently for each LED element (DR, DG, DB) of each color. The LED voltage setting circuit 42 generates the voltage control signal VCNT for each LED element (DR, DG, DB) of each color based on the mode switching signal. The AC-DC converter 45 generates LED voltage Vf (R, G, B) for each color according to the voltage control signal VCNT. The LED current setting circuit 43 generates the current control signal ICNT for each LED element (DR, DG, DB) of each color based on the mode switching signal and supplies the current control signal ICNT to the transistor Tr of each color in the LED driver 21. According to such a configuration, each of the LED current If and the LED voltage Vf is controlled according to the element properties of the LED element of each light emission color and each of the LED current If and the LED voltage Vf is set for each light emission color.

Specifically, as illustrated in FIG. 5, the LED current If and the LED voltage Vf are set as follows in the dynamic mode and the standard mode. For the red LED element DR, the LED current If is set to “I4” and the LED voltage Vf is set to “V2”. For the green LED element DG, the LED current If is set to “I3” and the LED voltage Vf is set to “V4”. For the green LED element DB, the LED current If is set to “I4” and the LED voltage Vf is set to “V4”. Each of the LED current If and the LED voltage Vf is set so as to be greater in the dynamic mode and the standard mode than in the Wall Picture mode.

In the Wall Picture mode that corresponds to the second display mode, power saving is given priority over the brightness in the LED backlight device 12. In the Wall Picture mode, the LED current If and the LED voltage Vf are set as follows. For the red LED element DR, the LED current If is set to “I2” and the LED voltage Vf is set to “V1”. For the green LED element DG, the LED current If is set to “I1” and the LED voltage Vf is set to “V3”. For the blue LED element DB, the LED current If is set to “I2” and the LED voltage Vf is set to “V3”. Each of the LED current If and the LED voltage Vf is set so as to be lower in the Wall Picture mode than in the dynamic mode. The relation of the amounts of the LED voltage Vf and the LED current If is as follows.

I1<I2<I3<I4

V1<V2<V3<V4

4. Advantages of the Embodiment

According to the present embodiment, each of the LED current If and the LED voltage Vf of the LED element (DR, DG, DB) for each light emission color is varied depending on the image display mode (dynamic mode, standard mode, wall Picture mode). Therefore, for example, in the image display mode (dynamic mode) in which high brightness is required rather than power saving, the LED current If and the LED voltage Vf increase from the normal values. In the image display mode in which power saving is required rather than the high brightness, the LED current If and the LED voltage Vf reduce from the normal values. In the present embodiment, in control of light emission brightness and power consumption of the LED element, the LED current Ir and the LED voltage Vf are arbitrarily set and changed. Therefore, in the LED backlight device 12, high brightness and power saving is appropriately achieved depending on the image display mode of the television receiver TV (liquid crystal display device 10).

### OTHER MODIFICATIONS

The embodiments of the present invention have been described, however, the present invention is not limited to the above embodiments explained in the above description and the drawings. The following embodiments may be included in the technical scope of the present invention, for example.

(1) In the above embodiment, the LED backlight device (light emitting device for image display) 12 does not include the image data process circuit 31 and the LED control section 40 and they are included in the display control section 30 of the liquid crystal display device 10. However, the LED backlight device as an independent device may include the image data process circuit 31 and the LED control section 40. Also, in the liquid crystal display device 10, the LED backlight device 12 may include the LED control section 40.

(2) In the above embodiment, as illustrated in FIG. 4, each LED driver 21 and each light emitting diode (LED unit 20) correspond to each other with one-to-one relation. However, for example, one LED driver 21 may drives a plurality of LED units 20. In such a case, the LEDs are connected to each other with cascade connection for each light emission color and one transistor Tr may drive the LEDs for each light emission color.

(3) In the above embodiment, the light emitting device for image display of the present invention is applied to the LED backlight device 12 of the liquid crystal display device 10, however, it is not limited thereto. For example, the light emitting device for image display of the present invention can be applied to an LED type Aurora Vision (registered trademark).

1. A light emitting device for image display including an LED element and controlling light emission of the LED element depending on an image display mode, the light emitting device comprising:
an LED current setting circuit configured to generate a current control signal to vary an element current flowing in the LED element depending on the image display mode;
a current control circuit configured to control the element current of the LED element according to the current control signal;
an LED voltage setting circuit configured to generate a voltage control signal to vary driving voltage driving the LED element depending on the image display mode; and
a voltage generation circuit configured to generate driving voltage according to the voltage control signal depending on the image display mode and apply the driving voltage to the LED element.

2. The light emitting device according to claim 1, wherein:
the image display mode includes a first display mode that requires high brightness rather than power saving and a second display mode that requires power saving rather than high brightness; and
in the first display mode, the LED current setting circuit generates the current control signal such that the element current is greater than that in the second display mode and the LED voltage setting circuit generates the voltage control signal such that the driving voltage is greater than that in the second display mode.

3. The light emitting device according to claim 1 further comprising:
a plurality of divided light emission regions; and
a plurality of LED units each provided to correspond to each light emission region and each including at least one LED element.

4. The light emitting device according to claim 3, wherein each of the LED units includes a plurality of LED elements emitting light in different colors.

5. The light emitting device according to claim 4, wherein:
the LED current setting circuit generates the current control signal for each light emission color;
the current control circuit controls the element current of the LED element for each light emission color according to the current control signal for each light emission color;
the LED voltage setting circuit generates the voltage control signal for each light emission color; and
the voltage generation circuit generates the driving voltage for each light emission color according to the voltage control signal for each light emission color and applies the driving voltage for each light emission color to the LED element for each light emission color.

6. The light emitting device according to claim 1, wherein the LED element is electrically controlled by a PWM signal, the light emitting device further comprising:
an image data process circuit configured to generate light emission brightness data of the LED element based on image data for image display and vary the light emission brightness data depending on the image display mode; and
a PWM signal generation circuit configured to generate the PWM signal based on the variable light emission brightness data.

7. The light emitting device according to claim 1, wherein the light emitting device is a backlight device displaying images by illuminating a rear side of an object to be illuminated with light.

8. The light emitting device according to claim 7, wherein the object to be illuminated is a liquid crystal panel.

9. A display device comprising:
the light emitting device according to claim 1; and
a display panel configured to provide display using light from the light emitting device.

10. The display device according to claim 9, wherein the display panel is a liquid crystal display using liquid crystal.

11. A television receiver comprising the display device according to claim 9.
